(19) United States
(12) Patent Application Publication
(10) Pub. No.: US 2026/0149951 A1
(43) Pub. Date: May 28, 2026

(54) SYSTEMS AND METHODS FOR LOCAL USER EQUIPMENT INFORMATION REPOSITORY AT SHORT MESSAGE SERVICE CENTER IN A WIRELESS NETWORK

(71) Applicant: Verizon Patent and Licensing Inc., Basking Ridge, NJ (US)

(72) Inventors: Kevin Lim, Danville, CA (US); Craig A. Barth, Denton, TX (US); Robert Avanes, Roanoke, TX (US)

(73) Assignee: Verizon Patent and Licensing Inc., Basking Ridge, NJ (US)

(21) Appl. No.: 18/957,991

(22) Filed: Nov. 25, 2024

(51) Int. Cl. H04W 4/14; H04W 8/04; H04W 8/22

(52) U.S. Cl. CPC H04W 4/14; H04W 8/04; H04W 8/22

(57) ABSTRACT

A system described herein may output, by a Short Message Service Center (“SMSC”) and to a User Equipment (“UE”) information repository of a wireless network, a request to provide UE information, associated with a plurality of UEs, on an ongoing basis; receive, from the UE information repository and based on the request to provide the UE information on an ongoing basis, updated UE information associated with a particular UE of the plurality of UEs; maintain the updated UE information in a local UE information repository that is separate from the UE information repository of the wireless network; receive a Short Message Service (“SMS”) message associated with the particular UE; identify the updated UE information associated with the particular UE, as maintained in the local UE information repository; and forward the SMS message based on the updated UE information identified from the local UE information repository.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. One service provided by a wireless network may include Short Message Service (“SMS”) messaging, sometimes known as “texting.” Wireless networks may provide such services on behalf of UEs registered to wireless networks (e.g., as a “home” network of such UEs). Wireless networks may accordingly maintain UE information associated with registered UEs, indicating that the UEs are registered to the wireless networks. The UE information may also include mobility or location-based information, such as a particular Call Session Control Function (“CSCF”) (e.g., out of a set of potential CSCFs) that has been selected to provide functionality that facilitates SMS functionality for one or more respective UEs. A system that provides SMS functionality to UEs registered to multiple different wireless networks may include an SMS Center (“SMSC”), which may communicate with respective UE information repositories of the different wireless networks in order to facilitate SMS services for UEs registered to such wireless networks.

### BRIEF DESCRIPTION OF THE DRAWINGS

FIGS. 1 and 2 illustrate an example overview of one or more embodiments described herein;

FIG. 3 illustrates an example of aggregating UE information from multiple wireless networks, in accordance with some embodiments;

FIG. 4 illustrates an example of distributed sets of SMSCs, in accordance with some embodiments;

FIG. 5 illustrates an example process for maintaining and utilizing a local UE information repository, in accordance with some embodiments;

FIGS. 6 and 7 illustrate example environments in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Wireless networks that provide SMS services may include or may communicate with one or more SMSCs. SMCs may, for example, which provide services such as buffering SMS messages, forwarding SMS messages (e.g., to a particular wireless network that is operated by a given Mobile Network Operator (“MNO”)), and/or other suitable SMS-related services. In typical scenarios, when handling SMS messages, the SMSC may communicate with UE information repositories of respective wireless networks with which the SMS messages are registered. The UE information repository for a given wireless network may include, for example, a Home Subscriber Server (“HSS”), a Home Location Register (“HLR”), or the like. The SMSC may communicate with the UE information repository in order to obtain UE information, such as confirmation of whether a given UE is registered with a particular wireless network, whether the given UE is authorized to send or receive SMS messages, routing information associated with the given UE, or other suitable information. The routing information may include, for example, an identifier of one or more SMS-related network elements with which the given UE is associated, such as a Call Session Control Function (“CSCF”). In other aspects, other network elements may communicate with a UE information repository to obtain UE information as well.

In such implementations, a relatively large amount of messaging may occur between particular network elements (e.g., the SMSC) and UE information repositories of one or more wireless networks (e.g., Diameter protocol messaging), as the network element may communicate with one or more UE information repositories as part of processing network actions, such as each SMS out of thousands or millions of messages over time. Additionally, the processing of SMS messages may potentially be delayed in situations where communications between the SMSC and the UE information repository are undergoing connectivity and/or performance issues.

Embodiments described herein provide for reduced messaging between a network element and a UE information repository of one or more wireless networks, thus conserving network resources. Additionally, as discussed herein, the network element and one or more UE information repositories may communicate with each other in a manner that is asynchronous to, or is otherwise not dependent on, the forwarding of messages and signals related to the particular network element. In one example, the network element is an SMSC, and the messages may include SMS messages. In this manner the likelihood of messages or signals, such as SMS messages, being delayed due to or otherwise impacted by communications between the SMSC and a UE information repository may be reduced or eliminated.

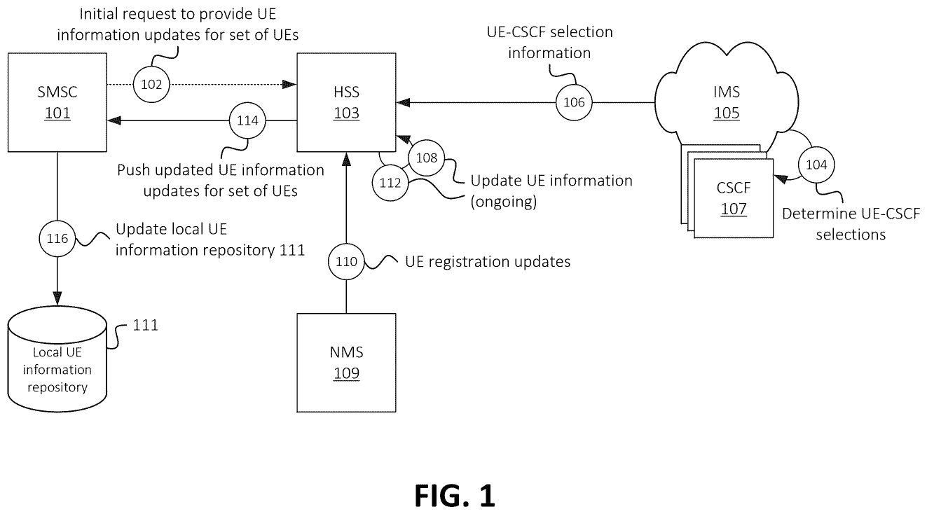

As shown in FIG. 1, for example, a particular SMSC 101 may output (at 102) a request to a UE information repository of a wireless network, such as a particular Home Subscriber Server (“HSS”) 103. In the examples described herein, HSS 103 is provided is an example UE information repository. In some embodiments, other types of UE information repositories may be used, such as an HLR, a Unified Data Management function (“UDM”), a Unified Data Repository (“UDR”), or the like. In some embodiments, SMSC 101 may communicate with HSS 103 via a Network Exposure Function (“NEF”), a Service Capability Exposure Function (“SCEF”), or some other suitable interface or communication pathway.

The request (at 102) may include a request for HSS 103 to provide, or “push,” UE information to SMSC 101. This request may be an initial or one-time request for information associated with a single UE or with multiple UEs. SMSC 101 may, for example, make such request based on receiving a communication (e.g., an SMS message) from a particular UE or directed to the particular UE. In such embodiments, SMSC 101 may make such requests on an on-demand basis, in order to ultimately maintain a local copy of UE information for UEs that are served by SMSC 101, as discussed below. In another example, SMSC 101 may output (at 102) the request as part of a configuration or update operation of SMSC 101. For example, an MNO and/or some other entity may provide identifiers of one or more UEs (e.g., UEs that have registered with the MNO, UEs that have entered one or more coverage areas or tracking areas served by the MNO, etc.) to SMSC 101, and SMSC 101 may in turn communicate with HSS 103 (e.g., which may be associated with a “home” network with which the UEs are registered) to request (at 102) UE information updates for such UEs. In some embodiments, SMSC 101 may identify or determine the set of UEs in some other suitable manner.

In some embodiments, SMSC 101 may output (at 102) requests (e.g., “pull” requests) to HSS 103 on a periodic basis (e.g., every hour, every day, every week, etc.), in order to regularly maintain an up-to-date set of UE information for one or more UEs. In some embodiments, SMSC 101 may modify an interval or frequency at which SMSC 101 outputs ongoing requests to HSS 103, such as in situations where SMSC 101 does not receive a response to the request for some time. For example, in the event of an outage or failure, HSS 103 may not be available to provide the requested UE information. In order to conserve network resources, SMSC 101 may issue such requests on a decaying or decelerating basis when a request is not received to such requests. For example, SMSC 101 may initially output the requests on an hourly basis, and may gradually increase the interval such as to a basis of every four hours or every day if responses to the request are not received.

In some embodiments, SMSC 101 may output a request for updated UE information for one or more UEs if SMSC 101 has not received updated UE information for at least a threshold amount of time. For example, if SMSC 101 receives UE information for a particular UE and then does not again receive UE information for the same particular UE within three days, SMSC 101 may output a request to HSS 103 to provide UE information for the particular UE. In this manner, SMSC 101 may ensure that locally maintained UE information is relatively “fresh” or is not outdated.

In some embodiments, SMSC 101 may more frequently output (at 102) requests (e.g., “pull” requests) for UE information during times of relatively low network congestion or activity, and may less frequently output (e.g., throttle) requests for UE information during times of relatively higher network congestion or activity. In this sense, the conservation of network resources during more critical times (e.g., times of heavy usage or congestion) may be maximized, while more frequently requesting updates when bandwidth is more readily available.

The request (at 102) may include one or more identifiers of the set of UEs, such as International Mobile Station Equipment Identity (“IMEI”) values, International Mobile Subscriber Identity (“IMSI”) values, Subscription Permanent Identifiers (“SUPIs”), Mobile Directory Numbers (“MDNs”), and/or other suitable identifiers. Additionally, or alternatively, the request may specify UE device types (e.g., smartphones, IoT devices, M2M devices, etc.) or other suitable attributes that may be used to indicate a set of UEs for which information is being requested.

In some embodiments, the request may indicate one or more types of information being requested. For example, SMSC 101 may request UE-CSCF selection information updates, UE registration and/or authorization updates, and/or other types of information as discussed below. In some embodiments, SMSC 101 may issue “pull” requests for different types of information on different intervals or otherwise asynchronously. For example, SMSC 101 may issue “pull” requests for UE registration information on a less frequent basis than SMSC 101 issues “pull” requests for UE-CSCF selection information.

As discussed above, HSS 103 may receive or maintain UE information, such as whether a given UE is registered with a particular wireless network or MNO, whether the UE is authorized to send or receive SMS messages, routing information associated with the UE, and/or other suitable information. The routing information may include or may be based on, for example, a selection (at 104) of one or more Network Functions (“NFs”) or NF instances to serve the UE (e.g., to route SMS messages to or from the UE). For example, a particular wireless network may include a particular Internet Protocol (“IP”) Multimedia Subsystem (“IMS”) network 105, which may aid in the delivery or routing of SMS messages to and/or from UEs. As shown, IMS network 105 may include multiple CSCFs 107 (e.g., multiple CSCF instances). For example, a first CSCF 107 (e.g., a first CSCF instance) may be located in a first region (e.g., may serve UEs located in the first region), a second CSCF 107 (e.g., a second CSCF instance) may be located in a second region, and so on. As another example, a first CSCF 107 may serve a first device type, and a second CSCF 107 may serve a second device type.

In practice, CSCFs 107 include different types of CSCFs, such as Interrogating CSCFs (“I-CSCFs”), Serving CSCFs (“S-CSCFs”), and/or Interrogating CSCFs (“I-CSCFs”). In some embodiments, an I-CSCF of IMS network 105 may determine (at 104) UE-CSCF selections (e.g., may assign or associate respective UEs to particular S-CSCFs). For example, the I-CSCF may assign a particular CSCF 107 (e.g., a particular S-CSCF to a particular UE based on a location of the UE, a device type of the UE, and/or other suitable factors). In one scenario, a UE may move from a first location to a second location. In this scenario, IMS network 105 may select a first CSCF 107 (e.g., a first S-CSCF) to serve the UE when the UE is in the first location, and may select a second CSCF 107 (e.g., a second S-CSCF) to serve the UE when the UE is in the second location.

IMS network 105 (e.g., one or more I-CSCFs of IMS network 105) may provide (at 106) UE-CSCF selection information. IMS network 105 may, for example, provide such information on an ongoing basis, such as a real-time event-driven basis (e.g., upon determining new UE-CSCF selections), a periodic basis, or on some other suitable basis. The UE-CSCF selection information may include one or more identifiers of one or more UEs (e.g., IMEIs, IMSIs, MDNs, etc.) along with identifiers (e.g., IP addresses, hostnames, instance identifiers, or the like) of respective CSCFs 107 with which such UEs have been associated.

HSS 103 may accordingly update (at 108) UE information associated with the UE (or UEs) for which UE-CSCF selection information was provided. For example, HSS 103 may maintain the identifier of an indicated CSCF 107 along with an indication that such CSCF 107 is associated with one or more particular UE identifiers. As such, when receiving requests for UE information (e.g., from one or more SMSCs 101, from one or more NFs associated with the same MNO that operates or manages HSS 103, and/or from some other authorized source), HSS 103 may be able to provide information indicating with which particular CSCF 107 a given UE is associated.

As another example of UE information maintained by HSS 103, HSS 103 may receive (at 110) UE registration updates from Network Management System (“NMS”) 109. The UE registration updates may indicate, for example, whether a particular UE is registered with a given MNO or wireless network, whether the UE is authorized to send and/or receive SMS messages, SMS usage limits associated with one or more respective UEs, and/or other suitable UE information. NMS 109 may, for example, have authorization or capabilities to provision or otherwise manage a given wireless network (e.g., a particular wireless network associated with a particular MNO). NMS 109 may provide such updates in situations where, for example, a new UE is registered or provisioned with such wireless network, a UE is transferred from one MNO to another, a UE is de-registered or de-provisioned from a wireless network, and/or in other situations. NMS 109 may provide (at 110) the UE registration updates periodically, on an event-driven basis (e.g., based on registration, de-registration, transfer, etc.), or on some other suitable basis.

HSS 103 may accordingly update (at 112) UE information associated with the UE (or UEs) for which UE registration updates were provided. For example, HSS 103 may maintain a flag, status, label, or the like (e.g., indicating a registration status) of one or more UEs along with one or more UE identifiers of such UEs. As such, when receiving requests for UE information, HSS 103 may be able to provide information indicating whether a given UE is registered with a given MNO or wireless network, whether the UE is authorized to send or receive SMS messages, etc.

In accordance with some embodiments, when receiving (e.g., at 106 and/or 110) updated UE information and/or when updating (e.g., at 108 and/or 112) UE information, HSS 103 may “push” or may otherwise provide (at 114) the updated UE information to SMSC 101. For example, when a particular UE update meets criteria specified in the request (at 102), such as matching an indicated UE identifier, device type, a particular type of UE update, and/or other suitable set of attributes, HSS 103 may provide such updated UE information to SMSC 101. In this sense, SMSC 101 may receive, on an ongoing basis (e.g., in real-time or near real-time), updated UE information, without needing to manually and repeatedly issue requests (such as the request at 102) for such information.

In some embodiments, SMSC 101 may locally maintain, and/or may be communicatively coupled to, Local UE Information Repository (“LUIR”) 111, and may update (at 116) LUIR 111 on an ongoing basis (e.g., based on updated UE information received at 114 on an ongoing basis). In some embodiments, LUIR 111 may include one or more storage devices, cloud systems, databases, or other suitable devices or systems that are capable of maintaining some or all of the UE information received (e.g., at 114) SMSC 101. In some embodiments, LUIR 111 may be “local” to SMSC 101, inasmuch as LUIR 111 may be maintained by a co-located set of hardware resources as SMSC 101, may be associated with the same logical or physical network domain as SMSC 101, may be communicatively coupled to SMSC 101 with fewer routing hops than a quantity of routing hops between SMSC 101 and HSS 103, may be accessible to a different set of devices or systems than a set of devices or systems that are able to access HSS 103, etc. In some scenarios, communications between SMSC 101 and LUIR 111 may exhibit lower latency than communications between SMSC 101 and HSS 103. In some embodiments, SMSC 101 may be communicatively coupled to LUIR 111 via a private network, a dedicated interface, or some other type of communication pathway that is managed or is configured by an owner or operator of SMSC 101 (e.g., where a communication pathway between SMSC 101 and HSS 103 may not be entirely within the management of the owner or operator of SMSC 101).

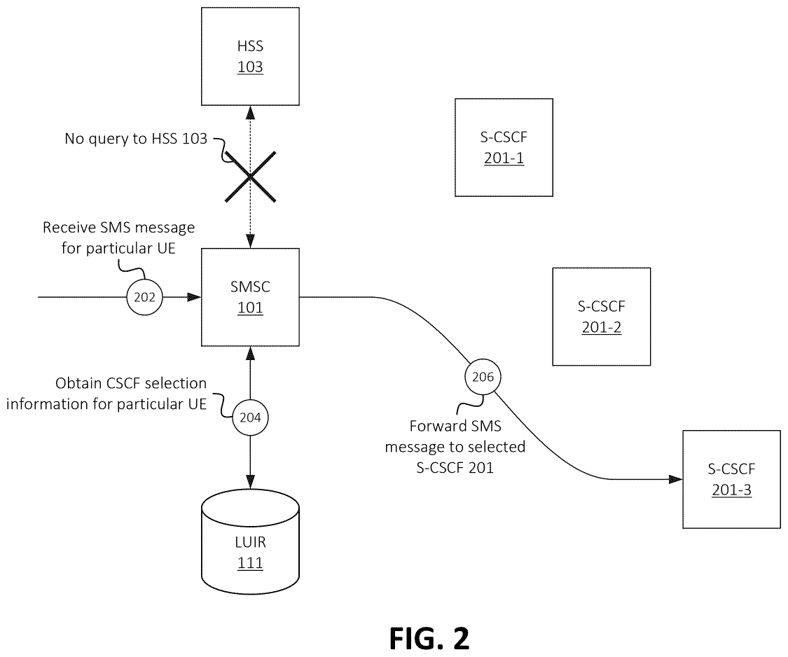

The established communication pathway between SMSC 101 and LUIR 111 (e.g., the coordinated management of SMSC 101 and LUIR 111) may allow for reduced latency of SMS communications handled by SMSC 101, as well as reduced messaging (e.g., Diameter messaging) between SMSC 101 and HSS 103. For example, as shown in FIG. 2, SMSC 101 may receive (at 202) an SMS message for a particular UE (e.g., where the SMS message includes an MDN, an IP address, a Session Initiation Protocol (“SIP”) identifier, and/or some other suitable identifier of the particular UE). Assume that SMSC 101 has previously received (e.g., at 108 and/or 112) UE information associated with the particular UE, and has maintained (e.g., at 116) the UE information at LUIR 111.

In order to process (e.g., forward, deliver, route, etc.) the SMS message toward the particular UE, SMSC 101 may obtain (at 204) UE information associated with the particular UE from LUIR 111. As noted above, since SMSC 101 is able to obtain the UE information from LUIR 111, SMSC 101 does not need to query HSS 103 for the UE information, thus reducing network messaging between SMSC 101 and HSS 103, and further reducing the likelihood of impacting the performance of delivering the SMS message due to an outage or failure (e.g., an outage or failure of HSS 103 and/or of a communication link between SMSC 101 and HSS 103).

SMSC 101 may accordingly forward (at 206) the SMS message toward the UE, such as by forwarding the SMS message to a particular S-CSCF (e.g., S-CSCF 201-3) out of a set of candidate S-CSCFs of IMS network 105 (e.g., S-CSCFs 201-1, 201-2, and 201-3).

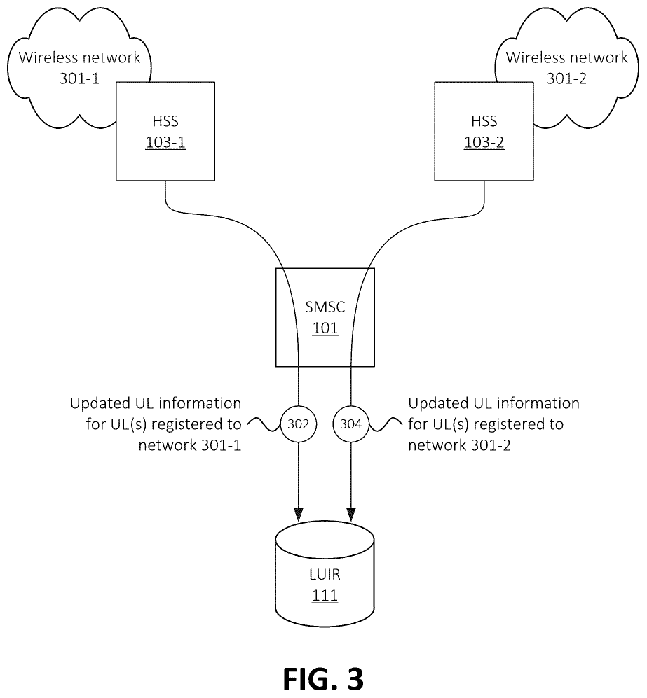

In some embodiments, LUIR 111 may further UE information associated with multiple wireless networks that are operated by multiple MNOs. For example, as shown in FIG. 3, SMSC 101 may communicate with wireless network 301-1 (e.g., with HSS 103-1 of wireless network 301-1 which may be operated by a first MNO) and with wireless network 301-2 (e.g., with HSS 103-2 of wireless network 301-2 which may be operated by a second MNO). In this manner, LUIR 111, with which SMSC 101 is communicatively coupled, may maintain (at 302) updated UE information for UEs registered to wireless network 301-1, and may also maintain (at 304) updated UE information for UEs registered to wireless network 301-2.

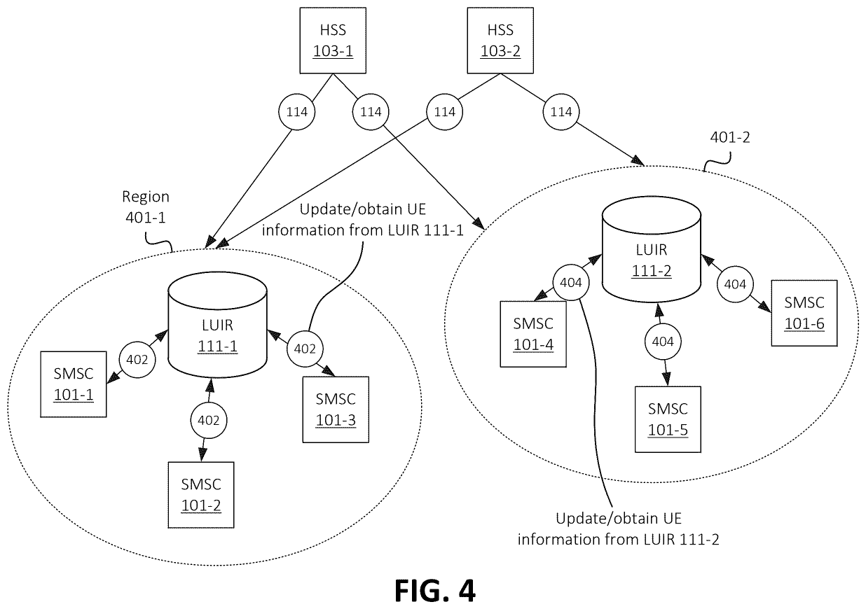

In some embodiments, the same LUIR 111 may be associated with or accessed by multiple SMSCs 101. For example, as shown in FIG. 4, a first set of SMSCs 101 (e.g., SMSC instances), such as SMSCs 101-1, 101-2, and 101-3 may be associated with (e.g., communicatively coupled to) a first LUIR 111-1, and a second set of SMSCs 101, such as SMSCs 101-4, 101-5, and 101-6, may be associated with (e.g., communicatively coupled to) a second LUIR 111-2. In one example, the first set of SMSCs may be associated with (e.g., located in, may serve, etc.) a first geographical region 401-1, and the second set of SMSCs may be associated with a second geographical region 401-2.

In other examples, the association of sets of SMSCs 101 with respective LUIRs 111 may be determined on some other basis, such as dedicated networks or communication pathways between a set of SMSCs 101 and a given LUIR 111. For example, SMSCs 101-1, 101-2, and 101-3 may have an established private network, dedicated interface, or other communication pathway with LUIR 111-1, and SMSCs 101-4, 101-5, and 101-6 may have an established private network, dedicated interface, or other communication pathway with LUIR 111-2.

SMSCs 101-1, 101-2, and 101-3 may accordingly update (at 402) UE information stored at LUIR 111-1, and may access (at 402) LUIR 111-1 to obtain UE information maintained by LUIR 111-1. In one example, SMSC 101-1 may receive (e.g., at 114) a UE information update associated with a particular UE, and SMSC 101-2 may subsequently access LUIR 111-1 to obtain the updated UE information. Similarly, SMSCs 101-4, 101-5, and 101-6 may update (at 404) UE information stored at LUIR 111-2, and may access (at 404) LUIR 111-2 to obtain UE information maintained by LUIR 111-2.

In some embodiments, the UE information maintained by LUIRs 111-1 and 111-2 may be different, inasmuch as the LUIRs 111-1 and 111-2 may maintain UE information for different sets of UEs. For example, the first set of SMSCs 101 may request (e.g., at 102) UE information for a first set of UEs and may accordingly update (at 402) LUIR 111-1 based on UE information received from HSS 103-1 and/or HSS 103-2, and the second set of SMSCs 101 may request (e.g., at 102) UE information for a second set of UEs and may accordingly update (at 404) LUIR 111-2 based on UE information received from HSS 103-1 and/or HSS 103-2.

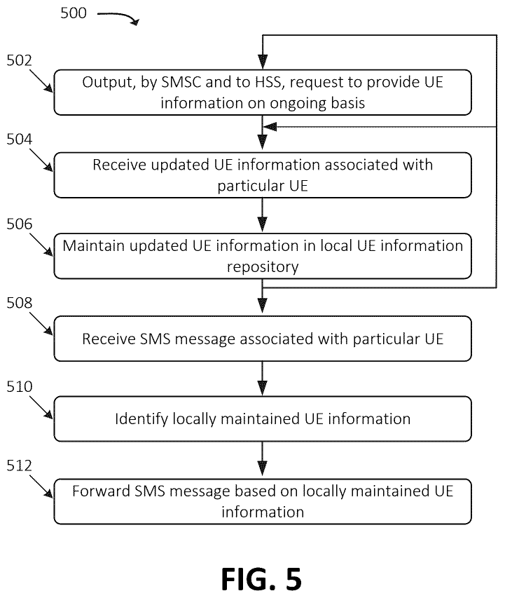

FIG. 5 illustrates an example process 500 for maintaining and utilizing a local UE information repository, in accordance with some embodiments. In some embodiments, some or all of process 500 may be performed by one or more SMSCs 101. While the examples herein are discussed in the context of being performed by SMSC 101, in practice, similar concepts may be performed by other types of network elements.

As shown, process 500 may include outputting (at 502) a request to provide UE information on an ongoing basis. For example, as discussed above, SMSC 101 may output a request to HSS 103 to provide updated UE information, and/or particular types of updated UE information associated with one or more specified UEs or groups of UEs, to SMSC 101. In some embodiments, the request may include a request to “push” the information to SMSC 101, such as in real-time, on some schedule, during times of relatively low network congestion, and/or on some other basis. In some embodiments, the request may include a Subscriber Notification Request (“SNR”).

Process 500 may further include receiving (at 504) updated UE information associated with a particular UE (e.g., out of a particular set of specified UEs). For example, HSS 103 may implement or output a Push Notification Request (“PNR”) based on receiving updates to UE information (e.g., from IMS network 105, NMS 109, and/or some other suitable device or system). The PNR may include an identifier of one or more UEs for which information was updated, and may include the updated information itself. In accordance with some embodiments, HSS 103 may leave the SNR (e.g., as received at 502) active or persistent, such as the SNR for UE information associated with the particular UE is still maintained by HSS 103 even after a PNR associated with the particular UE is sent by HSS 103.

Process 500 may additionally include maintaining (at 506) the updated UE information in a local UE information repository. For example, as discussed above, SMSC 101 may provide the updated UE information to LUIR 111. In embodiments where SMSC 101 is associated with a particular LUIR 111 out of a set of LUIRs 111, SMSC 101 may provide the updated UE information to the particular LUIR 111 with which SMSC 101 is associated.

Process 500 may also include receiving (at 508) an SMS message associated with the particular UE. For example, the particular SMS message may have been sent by another UE, and may include an identifier of the particular UE, such as an MDN, a SIP address, or the like.

Process 500 may further include identifying (at 510) locally maintained UE information associated with the particular UE. For example, as discussed above, SMSC 101 may access LUIR 111 to identify UE information for the particular UE, including the updated UE information previously provided (at 506) to LUIR 111. As discussed above, the UE information may include authorization information, such as whether the UE is authorized to send and/or receive SMS messages. Additionally, or alternatively, the UE information may include routing information, such as an identifier of a particular CSCF 107 (e.g., a particular S-CSCF 201) with which the particular UE is associated.

Process 500 may additionally include forwarding (at 512) the SMS message based on the identified locally maintained UE information. For example, SMSC 101 may forward the SMS message to the particular CSCF 107 (e.g., the particular S-CSCF 201) with which the UE is associated, which may proceed to forward the message to the particular UE. In some circumstances, such as when the UE information indicates that the UE is not authorized to send or receive SMS messages, SMSC 101 may reject the message (e.g., forgo forwarding the message to the particular UE, such as forgoing forwarding the message to the particular S-CSCF 201).

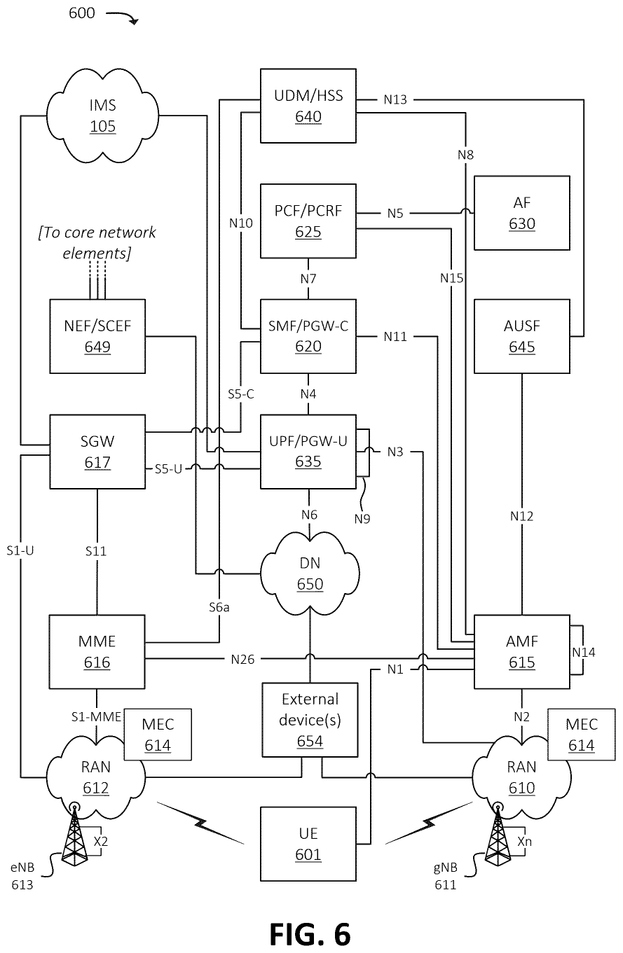

FIG. 6 illustrates an example environment 600, in which one or more embodiments may be implemented. In some embodiments, environment 600 may correspond to a Fifth Generation (“5G”) network, and/or may include elements of a 5G network. In some embodiments, environment 600 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 600 may represent or may include a 5G core (“5GC”). As shown, environment 600 may include UE 601, RAN 610 (which may include one or more Next Generation Node Bs (“gNBs”) 611), RAN 612 (which may include one or more evolved Node Bs (“eNBs”) 613), and various network functions such as Access and Mobility Management Function (“AMF”) 615, Mobility Management Entity (“MME”) 616, Serving Gateway (“SGW”) 617, Session Management Function (“SMF”)/Packet Data Network (“PDN”) Gateway (“PGW”)-Control plane function (“PGW-C”) 620, Policy Control Function (“PCF”)/Policy Charging and Rules Function (“PCRF”) 625, Application Function (“AF”) 630, User Plane Function (“UPF”)/PGW-User plane function (“PGW-U”) 635, UDM/HSS 640, Authentication Server Function (“AUSF”) 645, and Network Exposure Function (“NEF”)/Service Capability Exposure Function (“SCEF”) 649. Environment 600 may also include one or more networks, such as Data Network (“DN”) 650. Environment 600 may include one or more additional devices or systems communicatively coupled to one or more networks (e.g., DN 650), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple “slices” of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service (“QoS”) parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions (“VNFs”), Cloud-Native Network Functions (“CNFs”), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes^{®}application programming interface (“API”) or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 600 may be, may include, may be implemented by, and/or may be communicatively coupled to wireless network 301.

UE 601 may include a computation and communication device, such as a wireless mobile communication device that is capable of communicating with RAN 610, RAN 612, and/or DN 650. UE 601 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a programmable logic controller or other industrial controller, an M2M device, or the like), a Fixed Wireless Access (“FWA”) device, or another type of mobile computation and communication device. UE 601 may send traffic to and/or receive traffic (e.g., user plane traffic) from DN 650 via RAN 610, RAN 612, and/or UPF/PGW-U 635.

RAN 610 may be, or may include, a 5G RAN that implements a 5G RAT and that includes one or more base stations (e.g., one or more gNBs 611), via which UE 601 may communicate with one or more other elements of environment 600. UE 601 may communicate with RAN 610 via an air interface (e.g., as provided by gNB 611). For instance, RAN 610 may receive traffic (e.g., user plane traffic such as voice call traffic, data traffic, messaging traffic, etc.) from UE 601 via the air interface, and may communicate the traffic to UPF/PGW-U 635 and/or one or more other devices or networks. Further, RAN 610 may receive signaling traffic, control plane traffic, etc. from UE 601 via the air interface, and may communicate such signaling traffic, control plane traffic, etc. to AMF 615 and/or one or more other devices or networks. Additionally, RAN 610 may receive traffic intended for UE 601 (e.g., from UPF/PGW-U 635, AMF 615, and/or one or more other devices or networks) and may communicate the traffic to UE 601 via the air interface.

RAN 612 may be, or may include, an LTE RAN that implements an LTE RAT and that includes one or more base stations (e.g., one or more eNBs 613), via which UE 601 may communicate with one or more other elements of environment 600. UE 601 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 601 via the air interface, and may communicate the traffic to UPF/PGW-U 635 (e.g., via SGW 617) and/or one or more other devices or networks. Further, RAN 612 may receive signaling traffic, control plane traffic, etc. from UE 601 via the air interface, and may communicate such signaling traffic, control plane traffic, etc. to MME 616 and/or one or more other devices or networks. Additionally, RAN 612 may receive traffic intended for UE 601 (e.g., from UPF/PGW-U 635, MME 616, SGW 617, and/or one or more other devices or networks) and may communicate the traffic to UE 601 via the air interface.

One or more RANs of environment 600 (e.g., RAN 610 and/or RAN 612) may include, may implement, and/or may otherwise be communicatively coupled to one or more edge computing devices, such as one or more Multi-Access/Mobile Edge Computing (“MEC”) devices (referred to sometimes herein simply as a “MECs”) 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 601, via RAN 610 and/or 612. For example, RAN 610 and/or 612 may route some traffic from UE 601 (e.g., traffic associated with one or more particular services, applications, application types, etc.) to a respective MEC 614 instead of to core network elements of 600 (e.g., UPF/PGW-U 635). MEC 614 may accordingly provide services to UE 601 by processing such traffic, performing one or more computations based on the received traffic, and providing traffic to UE 601 via RAN 610 and/or 612. MEC 614 may include, and/or may implement, some or all of the functionality described above with respect to UPF/PGW-U 635, AF 630, SMSC 101, LUIR 111, one or more application servers, and/or one or more other devices, systems, VNFs, CNFs, etc. In this manner, ultra-low latency services may be provided to UE 601, as traffic does not need to traverse links (e.g., backhaul links) between RAN 610 and/or 612 and the core network.

AMF 615 may include one or more devices, systems, VNFs, CNFs, etc., that perform operations to register UE 601 with the 5G network, to establish bearer channels associated with a session with UE 601, to hand off UE 601 from the 5G network to another network, to hand off UE 601 from the other network to the 5G network, manage mobility of UE 601 between RANs 610 and/or gNBs 611, and/or to perform other operations. In some embodiments, the 5G network may include multiple AMFs 615, which communicate with each other via the N14 interface (denoted in FIG. 6 by the line marked “N14” originating and terminating at AMF 615).

MME 616 may include one or more devices, systems, VNFs, CNFs, etc., that perform operations to register UE 601 with the EPC, to establish bearer channels associated with a session with UE 601, to hand off UE 601 from the EPC to another network, to hand off UE 601 from another network to the EPC, manage mobility of UE 601 between RANs 612 and/or eNBs 613, and/or to perform other operations.

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 601. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, CNFs, etc., that receive, store, and/or provide information that may be used in determining parameters (e.g., quality of service parameters, charging parameters, or the like) for certain applications.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 601, from DN 650, and may forward the user plane data toward UE 601 (e.g., via RAN 610, SMF/PGW-C 620, and/or one or more other devices). In some embodiments, multiple instances of UPF/PGW-U 635 may be deployed (e.g., in different geographical locations), and the delivery of content to UE 601 may be coordinated via the N9 interface (e.g., as denoted in FIG. 6 by the line marked “N9” originating and terminating at UPF/PGW-U 635). Similarly, UPF/PGW-U 635 may receive traffic from UE 601 (e.g., via RAN 610, RAN 612, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a UDR. AUSF 645 and/or UDM/HSS 640 may perform authentication, authorization, and/or accounting operations associated with one or more UEs 601 and/or one or more communication sessions associated with one or more UEs 601. In some embodiments, UDM/HSS 640 may include, may implement, may be implemented by, and/or may otherwise be associated with HSS 103.

DN 650 may include one or more wired and/or wireless networks. For example, DN 650 may include an IP-based PDN, a wide area network (“WAN”) such as the Internet, a private enterprise network, and/or one or more other networks. UE 601 may communicate, through DN 650, with data servers, other UEs 601, and/or to other servers or applications that are coupled to DN 650. DN 650 may be connected to one or more other networks, such as a public switched telephone network (“PSTN”), a public land mobile network (“PLMN”), and/or another network. DN 650 may be connected to one or more devices, such as content providers, applications, web servers, and/or other devices, with which UE 601 may communicate.

External devices 654 may include one or more devices or systems that communicate with UE 601 via DN 650 and one or more elements of 600 (e.g., via UPF/PGW-U 635). In some embodiments, external devices 654 may include, may implement, and/or may otherwise be associated with SMSC 101, LUIR 111, and/or some other device or system. External devices 654 may include, for example, one or more application servers, content provider systems, web servers, or the like. External devices 654 may, for example, implement “server-side” applications that communicate with “client-side” applications executed by UE 601. External devices 654 may provide services to UE 601 such as gaming services, videoconferencing services, messaging services, email services, web services, and/or other types of services. Operations described above with respect to a given external device 654 (e.g., in accordance with some embodiments) may be performed by a single device, by a cloud computing system, by one or more devices that implement a virtualized or containerized environment, a collection of devices, etc.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 650). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy (“SEPP”), which may perform some or all of the functions discussed above. External device 654 may, in some situations, subscribe to particular types of requested information provided by the one or more core network elements, and the one or more core network elements may provide (e.g., “push”) the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements (“SLAs”), etc. (e.g., maximum latency thresholds, minimum throughput thresholds, etc.) associated with the services.

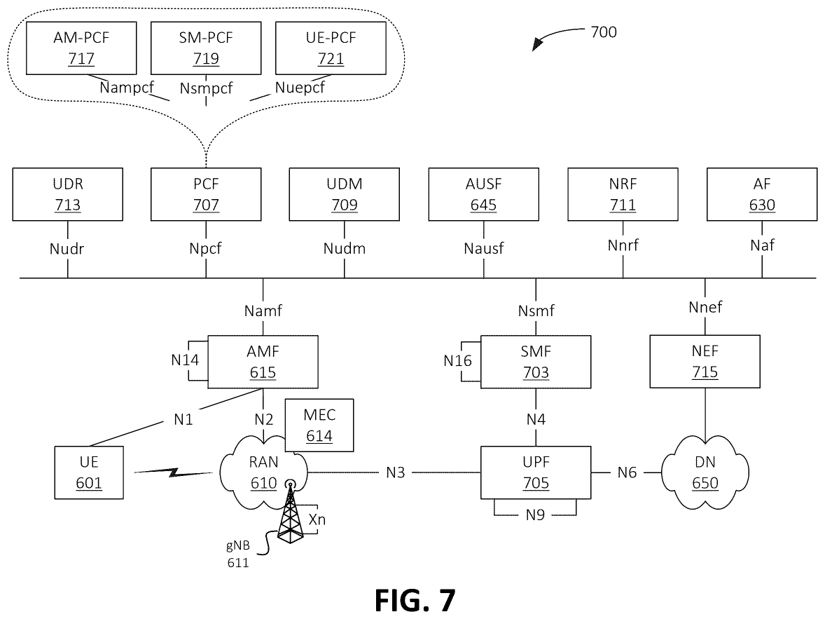

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 601, RAN 610 (which may include one or more gNBs 611 or other types of wireless network infrastructure) and various network functions, which may be implemented as VNFs, CNFs, etc. Such network functions may include AMF 615, SMF 703, UPF 705, PCF 707, UDM 709, AUSF 645, Network Repository Function (“NRF”) 711, AF 630, UDR 713, and NEF 715. Environment 700 may also include or may be communicatively coupled to one or more networks, such as DN 650.

The example shown in FIG. 7 illustrates one instance of each network component or function (e.g., one instance of SMF 703, UPF 705, PCF 707, UDM 709, AUSF 645, etc.). In practice, environment 700 may include multiple instances of such components or functions. For example, in some embodiments, environment 700 may include multiple “slices” of a core network, where each slice includes a discrete and/or logical set of network functions (e.g., one slice may include a first instance of SMF 703, PCF 707, UPF 705, etc., while another slice may include a second instance of SMF 703, PCF 707, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs. In some embodiments, environment 700 may be, may include, may be implemented by, and/or may be communicatively coupled to wireless network 301.

UPF 705 may include one or more devices, systems, VNFs, CNFs, etc., that receive, route, process, and/or forward traffic (e.g., user plane traffic). As discussed above, UPF 705 may communicate with UE 601 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 601) from DN 650, and may forward the downlink user plane traffic toward UE 601 (e.g., via RAN 610). In some embodiments, multiple UPFs 705 may be deployed (e.g., in different geographical locations), and the delivery of content to UE 601 may be coordinated via the N9 interface. Similarly, UPF 705 may receive uplink traffic from UE 601 (e.g., via RAN 610), and may forward the traffic toward DN 650. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 707 may include one or more devices, systems, VNFs, CNFs, etc., that aggregate, derive, generate, etc. policy information associated with the 5GC and/or UEs 601 that communicate via the 5GC and/or RAN 610. PCF 707 may receive information regarding policies and/or subscriptions from one or more sources, such as subscriber databases (e.g., UDM 709, UDR 713, etc.), and/or from one or more users such as, for example, an administrator associated with PCF 707. In some embodiments, the functionality of PCF 707 may be split into multiple network functions or subsystems, such as access and mobility PCF (“AM-PCF”) 717, session management PCF (“SM-PCF”) 719, UE PCF (“UE-PCF”) 721, and so on. Such different “split” PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 713 may include one or more devices, systems, VNFs, CNFs, etc. that provide user and/or subscriber information, based on which PCF 707 and/or other elements of environment 700 may determine access policies, QoS policies, charging policies, or the like. In some embodiments, UDR 713 may receive such information from UDM 709 and/or one or more other sources.

NEF 715 include one or more devices, systems, VNFs, CNFs, etc. that provide access to information, APIs, and/or other operations or mechanisms of the 5GC to devices or systems that are external to the 5GC. NEF 715 may maintain authorization and/or authentication information associated with such external devices or systems, such that NEF 715 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function (“CHF”) of the 5GC, and/or other suitable network function. NEF 715 may communicate with external devices or systems (e.g., external devices 654) via DN 650 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 707 may include, may implement, may be implemented by, and/or may otherwise be associated with a PCRF (e.g., PCF/PCRF 625); NEF 715 may include, may implement, may be implemented by, and/or may otherwise be associated with a SCEF (e.g., NEF/SCEF 649); and so on.

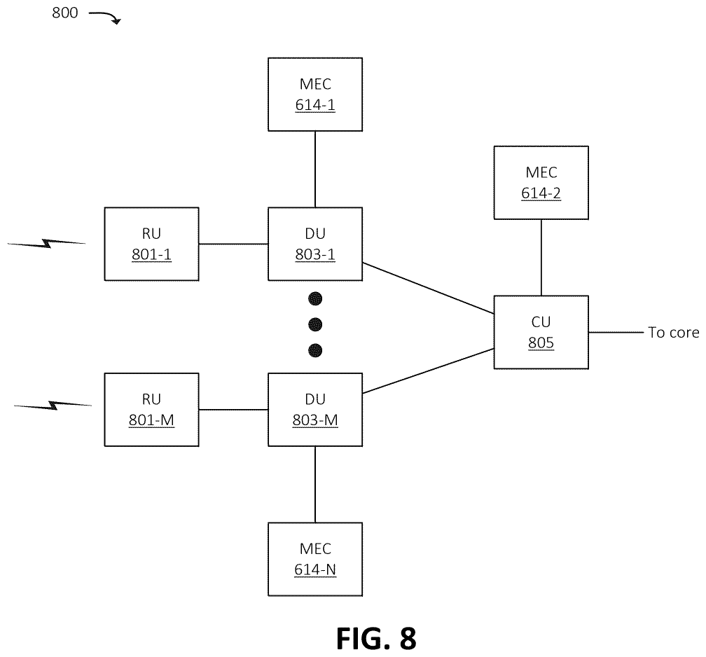

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include Central Unit (“CU”) 805, one or more Distributed Units (“DUs”) 803-1 through 803-M (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 601 to a core network), CU 805 may aggregate traffic from DUs 803, and forward the aggregated traffic to the core network. In some embodiments, CU 805 may receive traffic according to a given protocol (e.g., Radio Link Control (“RLC”) traffic) from DUs 803, and may perform higher-layer processing (e.g., may aggregate/process RLC packets and generate Packet Data Convergence Protocol (“PDCP”) packets based on the RLC packets) on the traffic received from DUs 803.

CU 805 may receive downlink traffic (e.g., traffic from the core network, traffic from a given MEC 614, etc.) for a particular UE 601, and may determine which DU(s) 803 should receive the downlink traffic. DU 803 may include one or more devices that transmit traffic between a core network (e.g., via CU 805) and UE 601 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 601.

RU 801 may include hardware circuitry (e.g., one or more RF transceivers, antennas, radios, and/or other suitable hardware) to communicate wirelessly (e.g., via an RF interface) with one or more UEs 601, one or more other DUs 803 (e.g., via RUs 801 associated with DUs 803), and/or any other suitable type of device. In the uplink direction, RU 801 may receive traffic from UE 601 and/or another DU 803 via the RF interface and may provide the traffic to DU 803. In the downlink direction, RU 801 may receive traffic from DU 803, and may provide the traffic to UE 601 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 601, via a respective RU 801.

For example, DU 803-1 may route some traffic, from UE 601, to MEC 614-1 instead of to a core network via CU 805. MEC 614-1 may process the traffic, perform one or more computations based on the received traffic, and may provide traffic to UE 601 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 601, as traffic does not need to traverse DU 803, CU 805, links between DU 803 and CU 805, and an intervening backhaul network between RAN environment 800 and the core network.

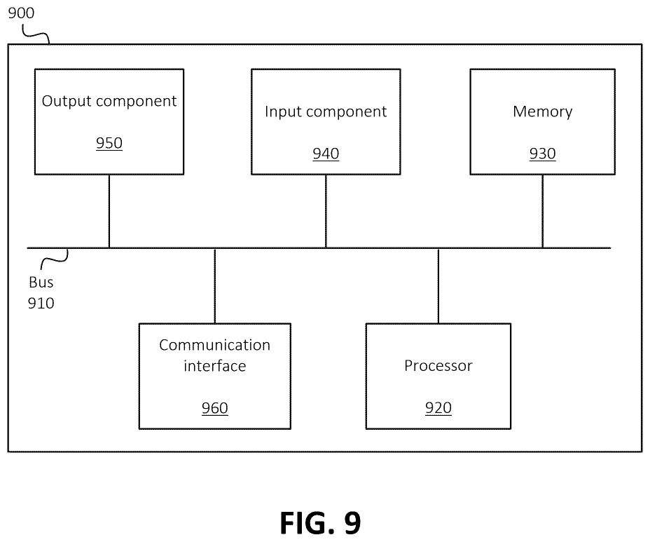

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems (e.g., via RAN 610, RAN 612, DN 650, etc.). For example, communication interface 960 may include an Ethernet interface, an optical interface, a coaxial interface, or the like. Communication interface 960 may include a wireless communication device, such as an infrared (“IR”) receiver, a Bluetooth^{®}radio, or the like. The wireless communication device may be coupled to an external device, such as a cellular radio, a remote control, a wireless keyboard, a mobile telephone, etc. In some embodiments, device 900 may include more than one communication interface 960. For instance, device 900 may include an optical interface, a wireless interface, an Ethernet interface, and/or one or more other interfaces.

Device 900 may perform certain operations relating to one or more processes described above. Device 900 may perform these operations in response to processor 920 executing instructions, such as software instructions, processor-executable instructions, etc. stored in a computer-readable medium, such as memory 930. A computer-readable medium may be defined as a non-transitory memory device. A memory device may include space within a single physical memory device or spread across multiple physical memory devices. The instructions may be read into memory 930 from another computer-readable medium or from another device. The instructions stored in memory 930 may be processor-executable instructions that cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
output, by a Short Message Service Center (“SMSC”) and to a User Equipment (“UE”) information repository of a wireless network, a request to provide UE information, associated with a plurality of UEs, on an ongoing basis;
receive, from the UE information repository and based on the request to provide the UE information on an ongoing basis, updated UE information associated with a particular UE of the plurality of UEs;
maintain the updated UE information in a local UE information repository that is separate from the UE information repository of the wireless network;
receive a Short Message Service (“SMS”) message associated with the particular UE;
identify the updated UE information associated with the particular UE, as maintained in the local UE information repository; and
forward the SMS message based on the updated UE information identified from the local UE information repository.

2. The device of claim 1, wherein identifying the updated UE information associated with the particular UE is performed without outputting a UE information subsequent request, after receiving the SMS message, to the UE information repository of the wireless network.

3. The device of claim 1, wherein the UE information repository of the wireless network includes at least one of:
a Home Subscriber Server (“HSS”),
a Unified Data Management function (“UDM”), or
a Unified Data Repository (“UDR”).

4. The device of claim 1, wherein outputting the request includes outputting the request to at least one of:
a Service Capability Exposure Function (“SCEF”), or
a Network Exposure Function (“NEF”).

5. The device of claim 1, wherein the SMSC is a first SMSC, wherein the local UE information repository further maintains UE information provided by at least a second SMSC, wherein the second SMSC accesses the local UE information repository to identify the updated UE information associated with the particular UE.

6. The device of claim 1, wherein the one or more processors are further configured to:
request UE information from the UE information repository at a first interval;
identify that UE information was not received in response to a particular request; and
based on identifying that the UE information was not received in response to the particular request, request UE information from the UE information repository at a reduced second interval.

7. The device of claim 1, wherein the updated UE information includes at least one of:
registration information indicating whether the particular UE is registered with the wireless network, or
Call Session Control Function (“CSCF”) selection information associated with the particular UE.

8. A non-transitory computer-readable medium, storing a plurality of processor-executable instructions to:
output, by a Short Message Service Center (“SMSC”) and to a User Equipment (“UE”) information repository of a wireless network, a request to provide UE information, associated with a plurality of UEs, on an ongoing basis;
receive, from the UE information repository and based on the request to provide the UE information on an ongoing basis, updated UE information associated with a particular UE of the plurality of UEs;
maintain the updated UE information in a local UE information repository that is separate from the UE information repository of the wireless network;
receive a Short Message Service (“SMS”) message associated with the particular UE;
identify the updated UE information associated with the particular UE, as maintained in the local UE information repository; and
forward the SMS message based on the updated UE information identified from the local UE information repository.

9. The non-transitory computer-readable medium of claim 8, wherein identifying the updated UE information associated with the particular UE is performed without outputting a UE information subsequent request, after receiving the SMS message, to the UE information repository of the wireless network.

10. The non-transitory computer-readable medium of claim 8, wherein the UE information repository of the wireless network includes at least one of:
a Home Subscriber Server (“HSS”),
a Unified Data Management function (“UDM”), or
a Unified Data Repository (“UDR”).

11. The non-transitory computer-readable medium of claim 8, wherein outputting the request includes outputting the request to at least one of:
a Service Capability Exposure Function (“SCEF”), or
a Network Exposure Function (“NEF”).

12. The non-transitory computer-readable medium of claim 8, wherein the SMSC is a first SMSC, wherein the local UE information repository further maintains UE information provided by at least a second SMSC, wherein the second SMSC accesses the local UE information repository to identify the updated UE information associated with the particular UE.

13. The non-transitory computer-readable medium of claim 8, wherein the plurality of processor-executable instructions further include processor-executable instructions to:
request UE information from the UE information repository at a first interval;
identify that UE information was not received in response to a particular request; and
based on identifying that the UE information was not received in response to the particular request, request UE information from the UE information repository at a reduced second interval.

14. The non-transitory computer-readable medium of claim 8, wherein the updated UE information includes at least one of:
registration information indicating whether the particular UE is registered with the wireless network, or
Call Session Control Function (“CSCF”) selection information associated with the particular UE.

15. A method, comprising:
outputting, by a Short Message Service Center (“SMSC”) and to a User Equipment (“UE”) information repository of a wireless network, a request to provide UE information, associated with a plurality of UEs, on an ongoing basis;
receiving, from the UE information repository and based on the request to provide the UE information on an ongoing basis, updated UE information associated with a particular UE of the plurality of UEs;
maintaining the updated UE information in a local UE information repository that is separate from the UE information repository of the wireless network;
receiving a Short Message Service (“SMS”) message associated with the particular UE;
identifying the updated UE information associated with the particular UE, as maintained in the local UE information repository; and
forwarding the SMS message based on the updated UE information identified from the local UE information repository.

16. The method of claim 15, wherein identifying the updated UE information associated with the particular UE is performed without outputting a UE information subsequent request, after receiving the SMS message, to the UE information repository of the wireless network.

17. The method of claim 15, wherein the UE information repository of the wireless network includes at least one of:
a Home Subscriber Server (“HSS”),
a Unified Data Management function (“UDM”), or
a Unified Data Repository (“UDR”).

18. The method of claim 15, wherein outputting the request includes outputting the request to at least one of:
a Service Capability Exposure Function (“SCEF”), or
a Network Exposure Function (“NEF”).

19. The method of claim 15, wherein the SMSC is a first SMSC, wherein the local UE information repository further maintains UE information provided by at least a second SMSC, wherein the second SMSC accesses the local UE information repository to identify the updated UE information associated with the particular UE.

20. The method of claim 15, wherein the updated UE information includes at least one of:
registration information indicating whether the particular UE is registered with the wireless network, or
Call Session Control Function (“CSCF”) selection information associated with the particular UE.
